(19) United States
(12) Patent Application Publication
(10) Pub. No.: US 2025/0030090 A1
(43) Pub. Date: Jan. 23, 2025

(54) LIQUID CONTAINER FOR CONTROLLING THE TEMPERATURE OF BATTERY CELLS, COMPRISING TWO MAIN BODIES

(71) Applicant: John Deere Electric Powertrain LLC, Moline, IL (US)

(72) Inventors: Helmut Kastler, Freistadt (AT); Matthias Palmetshofer, Freistadt (AT)

(21) Appl. No.: 18/708,903

(22) PCT Filed: Nov. 10, 2022
(86) PCT No.: PCT/AT2022/060391

§ 371 Date: May 9, 2024

(30) Foreign Application Priority Data
Nov. 11, 2021 (AT) A50900/2021

(51) Int. Cl. H01M 10/6568; B23K 20/10

(52) U.S. Cl. CPC H01M 10/6568; B23K 20/10

(57) ABSTRACT

A liquid container for controlling the temperature of battery cells (1) comprises two main bodies (2a, 2b), which, when assembled, delimit a flow channel (3). For ultrasonic welding, one main body (2a) has an at least partially peripherally extending groove (7) and one main body (2b) has an at least partially peripherally extending tongue (8) for insertion into the groove (7). A stable and fluid-tight connection between the main bodies (2a, 2b) is possible. Before the ultrasonic welding the width (11) of the tongue (8) exceeds the width (12) of the groove (7) and the lateral surfaces (13) of the tongue (8) form peripherally extending welding surfaces that are seated against the groove walls (14).

### FIELD OF THE INVENTION

The invention relates to a liquid container for controlling the temperature of battery cells comprising two main bodies which, when assembled, delimit a flow channel, wherein, for ultrasonic welding, one main body has an at least partially peripherally extending groove and one main body has an at least partially peripherally extending tongue for insertion into the groove.

### DESCRIPTION OF THE PRIOR ART

A device for controlling the temperature of battery cells is known from AT522361B1. The device has two main bodies which can be connected to each other by means of an ultrasonic welding process and which delimit a flow channel for a temperature-control liquid. The main bodies form openings into which battery cells are inserted. For joining the bodies by ultrasonic welding, one main body comprises a circumferential groove and the other main body comprises a circumferential tongue that engages in the groove. The tongue forms an energy direction transmitter that tapers towards the base of the groove and rests against the base of the groove before ultrasonic welding, resulting in a circumferential welding line between the tip of the energy direction transmitter and the base of the groove. By inducing ultrasonic waves, frictional heat is generated at this welding line, which leads to the melting of the groove and the tongue. Disadvantageously, a relatively high and long energy input is required for this front-end welding, as otherwise the material melted off by the energy direction transmitter will solidify before it forms a firm connection with the groove, which means that the liquid tightness of the flow channel cannot be guaranteed. However, the required increase in energy input on the other side can result in damage to the main body at the probe-main body contact surface.

### SUMMARY OF THE INVENTION

The invention is therefore based on the object of proposing a liquid container of the type described at the beginning, the main bodies of which can be connected quickly with a low energy input and at the same time enable a stable and liquid-tight connection between the main bodies, particularly in the case of excess pressure.

The invention solves the set object in that before ultrasonic welding, the width of the tongue exceeds the width of the groove and the lateral surfaces of the tongue form peripherally extending welding surfaces which are seated against the groove walls. As a result of the measures according to the invention, the tongue is clamped between the groove walls under pretension, whereby two contact surfaces serving as welding surfaces are formed in each case between a lateral surface of the tongue and a groove wall. Due to this additional application of force, even a relatively low energy input from the sonotrode leads to melting of the welding surfaces. During ultrasonic melting, a shear flow occurs between the groove wall and the lateral surface of the tongue, which promotes a material mixing of the melt of the different main bodies and thus a homogeneous joint. By providing two welding surfaces, in each case between a lateral surface of the tongue and a groove wall, a double shear joint is created after the ultrasonic welding process, which on the one hand ensures redundant assurance of the liquid tightness of the main bodies and on the other hand leads to improved mechanical stability due to the doubling of the welding joint cross-section. This results in improved sealing conditions, particularly in the event of overpressure in the liquid container, i.e. when the internal pressure exceeds the external pressure, especially within a liquid. In principle, only a part of each lateral surface of the tongue can serve as a welding surface, wherein the stability of the welded joint also increases as the welding surface increases. Preferably, the lateral surfaces of the tongue can be in full contact with the groove walls. In a preferred embodiment, the lateral surfaces of the tongue and the groove walls extend parallel to each other. The width of the tongue preferably refers to the largest width of the tongue base, i.e. that part of the tongue extending in the groove that does not form the possibly pointed tongue head. One main body, preferably the main body forming the groove, can be designed as a sealing plate, which serves as a cover for the other main body open towards the sealing plate. The groove and tongue can be formed partially peripherally extending. A plurality of tongue and groove joints can be provided that are separated from each other. Preferably, however, a single tongue and groove connection extends around the openings for the battery cells. In this case, the tongue can be formed by the wall of the main body containing the tongue. The cross-section of the tongue head of the tongue can taper towards the base of the groove, which on the one hand makes it easier to assemble the main bodies and on the other hand pre-centers the main body containing the tongue in the groove.

In particular, the liquid container for controlling the temperature of battery cells can be a temperature-control device for battery cells. The temperature-control device for battery cells comprises at least one battery cell and two main bodies, wherein for ultrasonic welding one main body has an at least partially peripherally extending groove and one main body has an at least partially peripherally extending tongue for insertion into the groove, wherein before ultrasonic welding the width of the tongue exceeds the width of the groove and the lateral surfaces of the tongue form peripherally extending welding surfaces which are seated against the groove walls. When assembled, the main bodies can define a flow channel. The battery cells can be arranged at least in sections in the flow channel. The flow channel can have an inlet and an outlet for a temperature-control liquid. The flow channel can be supplied with the temperature-control liquid via a pump.

In order to ensure that the liquid container can be used for efficient temperature control of battery cells in contact outside the liquid container, the main bodies can have passage openings for individual battery cells and delimit the flow channel. The flow channel can be filled with a temperature-control liquid, preferably a temperature control liquid, which flows directly to the battery cells. The end sections of a battery cell can protrude through two mutually opposite openings, wherein the jacket section between the end sections of the battery cells extends in the flow channel. In order to obtain a liquid-tight connection between the battery cells and the passage openings, the passage openings can be provided with ring seals surrounding the battery cells.

A sufficient contact force between the groove and the tongue, without causing damage to the tongue, especially when using thermoplastic materials such as polyamide, is achieved if the width of the tongue exceeds the width of the groove by 0.1 mm to 0.8 mm, preferably by 0.3 mm to 0.5 mm.

In order to enable a targeted discharge of the molten material during ultrasonic welding and at the same time to further improve the stability and tightness of the connection between the main bodies, it is proposed that a cavity is provided between the groove base and the tongue head of the inserted tongue before welding. This means that the tongue is not inserted into the groove up to the end stop, but a cavity is left free. This creates a reservoir into which the melt that occurs during the ultrasonic welding process can run off and in which it can solidify. To secure the cavity, one of the main bodies can form a stop for a stop surface of the other main body, which are arranged in such a way that their interaction prevents the tongue from hitting the groove base.

In order to ensure that a sufficiently large volume can be provided to accommodate the melt without increasing the required energy input and weakening the welded joint, the height of the cavity can correspond to 10% to 60% of the height of the groove. In the range below 10%, not enough melt can be absorbed. In the range above 60%, the welding surfaces are too small and the clamping force acting on the tongue from the groove is reduced too much, so that this would have to be compensated for by increasing the energy input generated by the sonotrode.

The melt not only flows into the cavity, but also emerges on the side of the welding surfaces facing away from the cavity. If the melt flows towards the flow channel on the inside of the main body and solidifies there, this can have a negative effect on the temperature control of the battery cells by changing the intended flow behavior. If the melt extends along the outside of the main body, connections or other components can be negatively affected. Therefore, in order to prevent the escaping melt from impairing the functionality of the device, it is recommended in a preferred embodiment of the device according to the invention that the main body having the groove has a melt channel adjoining the groove in the direction of the other main body. The melt channel has a greater width than the groove, resulting in melt channel sections on both lateral surfaces of the tongue, along which the melt emerging from the melt bath can flow, cool and solidify before reaching other areas of the device.

A sufficiently high stability of the connection between the main bodies can be achieved if the height of the welding surfaces between the lateral surfaces of the tongue and the groove walls is 1 mm to 3 mm, in particular 1.4 mm to 1.7 mm.

In order to prevent deformation of the tongue when the main bodies are assembled and at the same time save material costs, the tongue base can be 1 mm to 2 mm wide, in particular 1.2 mm to 1.4 mm.

A particularly compact device is obtained if the groove extends in the joining direction of the main bodies at the level of the passage openings of the main body provided with the groove. In particular, the groove is spaced apart from the passage openings transversely to the joining direction of the main bodies to be assembled in the direction of the edge area of the main body, as a result of which the passage openings are not in the near field of the sonotrode and thus unintentional melting of the passage openings or their seals can be prevented.

### BRIEF DESCRIPTION OF THE INVENTION

The subject matter of the invention is shown in the drawings by way of example, wherein:

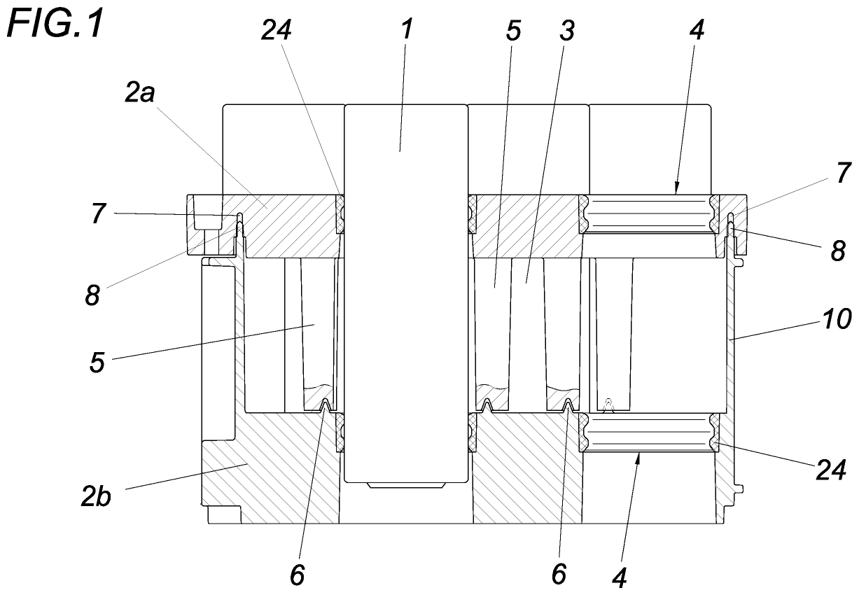

FIG. 1 shows a schematic sectional view of a device according to the invention for the temperature control of battery cells,

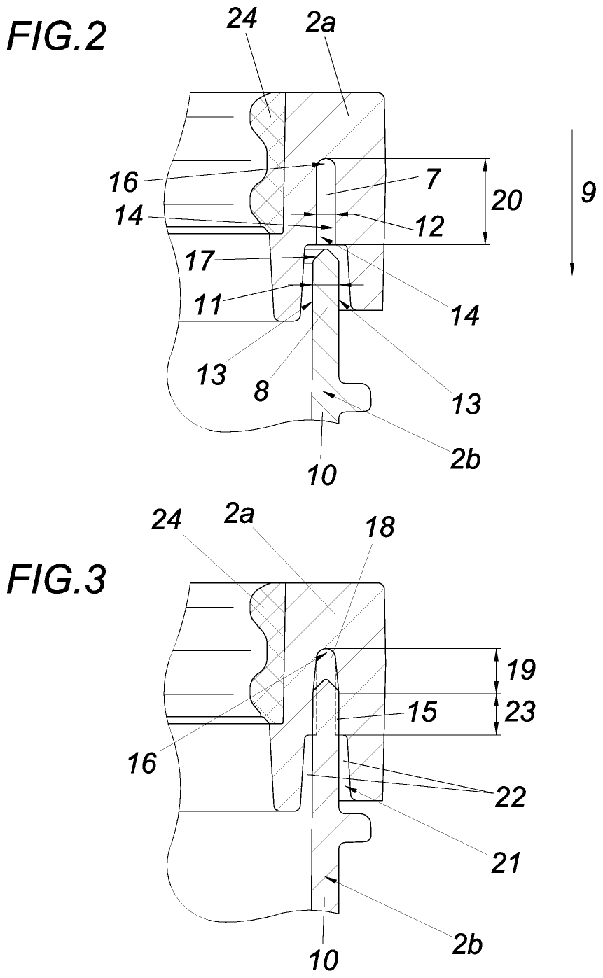

FIG. 2 shows a detailed view of the tongue and groove connection before the main bodies are assembled and before ultrasonic welding,

FIG. 3 shows a detailed view of the tongue and groove connection after assembly of the main bodies and before ultrasonic welding, and

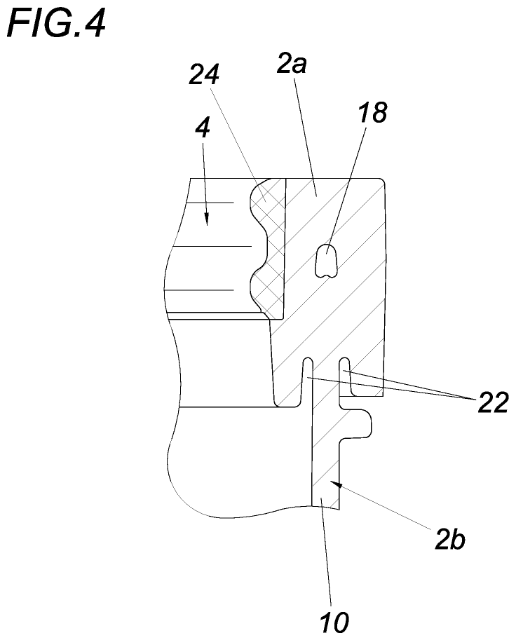

FIG. 4 shows a detailed view of the tongue and groove joint after the main bodies have been assembled and after ultrasonic welding.

### DETAILED DESCRIPTION OF THE PREFERRED EMBODIMENTS

A liquid container according to the invention, in particular a device for controlling the temperature of battery cells 1, has, as can be seen from FIG. 1, two main bodies 2a, 2b, which in the assembled state delimit a flow channel 3. The main bodies 2a, 2b can have passage openings 4 for the battery cells 1 to pass through. For each battery cell 1, two opposing passage openings 4 can be provided, each arranged in the other main body 2a, 2b, which receive the battery cells 1 on the end section side, so that the section of the battery cell 1 arranged between the passage openings 4 extends in the flow channel 3 and can be directly flowed against by a temperature-control liquid. One main body 2a can be designed as a sealing plate and serve as a cover for the other main body 2b, which is open towards the sealing plate. The main body 2a can have flow dividers 5 projecting into the flow channel 3, which allow the temperature-control liquid to circulate around the battery cells 1 in a guided manner. In order to ensure that the flow dividers 5 can be aligned to the positions intended for them, they can form receptacles for centering domes 6, which are arranged on the inner base surface of the main body 2b.

As can be seen in particular from FIGS. 2 and 3, the main body 2a has a groove 7 and the main body 2b has a tongue 8, whereby the main bodies 2a, 2b can be plugged together and then joined to each other by means of ultrasonic welding. The groove 7 and tongue 8 can extend partially transversely to the joining direction 9, but preferably can also be continuous, so that the tongue 8 can be formed by the wall 10 of the main body 2b. According to the invention, the width 11 of the tongue 8, in particular the largest width of the tongue base extending within the groove, is greater than the width 12 of the groove 7 before ultrasonic welding. In this way, in the assembled state, there is a peripherally extending contact surface between the lateral surfaces 13 of the tongue 8 and the groove walls 14, which acts as a welding surface 15. After ultrasonic welding, this results in a double circumferential shear joint, which can increase the stability and liquid tightness of the device.

The width 11 of the tongue 8 can exceed the width 12 of the groove 7 by 0.4 mm.

As disclosed in FIGS. 2 and 3, a cavity 18 can be provided between the groove base 16 and the tongue head 17, which can receive the melt flowing off from the melt bath (see FIG. 4). The height 19 of the cavity 18 can be 50% of the height 20 of the groove 7.

The main body 2a having the groove 7 can have a melt channel 21 adjoining the groove 7 in the direction of the other main body 2b, which can be wider than the groove 7. This results in two melt channel sections 22, along which the melt emerging from the melt bath can extend and solidify during cooling, as indicated in FIG. 4.

The height 23 of the welding surfaces 15 can be 1.5 mm. The width 11 of the tongue base can be 1.33 mm.

In terms of a compact device, the groove 7 can extend in the area of the passage openings 4. The passage openings 4 can have seals 24 for the battery cell 1.

1. A liquid container for controlling the temperature of battery cells (1), said liquid container comprising:
two main bodies that, when assembled, delimit a flow channel (3);
wherein one of the main bodies has groove walls defining an at least partially peripherally extending groove and the other of the main bodies has an at least partially peripherally extending tongue configured to be inserted into the groove and subjected to ultrasonic welding; and
wherein, before the ultrasonic welding, the tongue has a width that exceeds a width of the groove, and the tongue has lateral surfaces that form peripherally extending welding surfaces that are seated against the groove walls.

2. A device configured to control temperature of battery cells, said device having a liquid container according to claim 1, wherein the main bodies have passage openings associated with individual battery cells and delimit the flow channel so as to control the temperature of battery cells

3. The device according to claim 1, wherein the width of the tongue exceeds the width of the groove by 0.1 mm to 0.8 mm.

4. The device according to claim 1, wherein the groove base and the tongue head of the inserted tongue form a cavity therebetween before welding.

5. The device according to claim 4, wherein the cavity has a height that corresponds to 10% to 60% of a height of the groove.

6. The device according to claim 1, wherein the main body that has the groove has a melt channel adjoining the groove and extending toward the other main body.

7. The device according to claim 1, wherein the welding surfaces have a height between the lateral surfaces of the tongue and the groove walls is 1 mm to 3 mm.

8. The device according to claim 1, wherein the tongue has a tongue base that is 1 mm to 2 mm wide.

9. The device according to claim 2, wherein the groove (7) extends in a joining direction of the main bodies at a level of the passage openings of the main body that has the groove.

10. A temperature-control device comprising
at least one battery cell and two main bodies;
wherein one of the main bodies has groove walls defining an at least partially peripherally extending groove and the other of the main bodies has an at least partially peripherally extending tongue configured to be inserted into the groove and subjected to ultrasonic welding;
wherein, before ultrasonic welding, the tongue has a width that exceeds a width of the groove, and lateral surfaces of the tongue form peripherally extending welding surfaces that are seated against the groove walls.

11. The device according to claim 2, wherein the width of the tongue exceeds the width of the groove by 0.1 mm to 0.8 mm.

12. The device according to claim 1, wherein the width of the tongue exceeds the width of the groove by 0.3 mm to 0.5 mm.

13. The device according to claim 2, wherein the width of the tongue exceeds the width of the groove by 0.3 mm to 0.5 mm.

14. The device according to claim 1, wherein the welding surfaces have a height between the lateral surfaces of the tongue and the groove walls is 1.4 mm to 1.7 mm.

15. The device according to claim 1, wherein the tongue has a tongue base that is 1.2 mm to 1.4 mm wide.
